(19) United States
(12) Patent Application Publication
(10) Pub. No.: US 2003/0091162 A1
(43) Pub. Date: May 15, 2003

(54) Telephone data switching method and system

(76) Inventors: Christopher Haun, Richardson, TX (US); Tahsin Choudhuri, Plano, TX (US); Patrick Sollee, Richardson, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 09/992,217

(22) Filed: Nov. 14, 2001

(51) Int. Cl. H04M 1/64; H04M 1/00

(52) U.S. Cl. 379/80; 379/388.06

(57) ABSTRACT

A telephony data switching method includes receiving data from a first party and determining whether the data from the first party is substantially all speech data. If the data from the first party is ‘substantially all’ speech data, sending the data from the first party to the speaker and deactivating a data transfer state by preventing transfer of the data captured by a microphone operable to receive data from a second party and to receive data output by a speaker. If the data from the first party is not substantially all speech data, determining whether a silent data threshold has been reached. If the silent data threshold has been reached, the method also includes activating the data transfer state and recording data from the second party. If the data transfer state has been activated, the method includes sending the data from the second party to the first party.

### TECHNICAL FIELD OF THE INVENTION

The present invention relates in general to telecommunications and, more particularly, the invention is related to a telephony data switching method and system.

### BACKGROUND OF THE INVENTION

Many changes in inter-personal and inter-organizational communication have been enabled by developments in a variety of protocols and multimedia communications technology. For example, multimedia communication distribution allows text, voice and video to be used alone or in combinations to communication with a wide audience. Recent developments have been focused in transport and switching of traditional voice services over Internet Protocol (IP) networks. For example, some unified services such as integrated voice and data, email and web-enabled call center applications have been introduced. Many computers may service telephony servers that control, add intelligence, store, forward and manipulate various voice, data, fax and email calls flowing into and out of a computer telephony system. In some cases, a telephony server may also function as a switch.

Unfortunately, current technology provided by telephony applications that process the audio data into end-user devices such as microphones and speakers typically suffers from disadvantages. For example, telephony applications that run on personal computers (PCs) are intended to be used with these end-user devices and typically output incoming audio data through the PC's speakers. The voice output from the speakers is re-captured by the PC's microphone sent back to the originator, causing an echo. For example, typically the audio data spoken by a first party is captured at the first party's PC, and then sent to a second party's PC, where it is played on the second party's speaker. Unfortunately, this audio data played by the second party's speaker is typically picked up by the PC's microphone and sent back to the first party, causing the undesirable echo. That is, the first party hears an echo of everything he or she says. This undesirable effect is further compounded when two or more parties are utilizing a PC telephony application to conduct a conference call, where the parties are each speaking. In this scenario, echoes may be repeatedly picked up at each end, resulting in a continuous echo loop of the same sounds.

This undesirable result typically encourages users of PC telephony systems to purchase a headset or other external microphone to utilize applications hosted on the PC. Another possible remedy requires the user to continually readjust the settings for the PC's speaker and microphone volume. These readjustments may temporarily and intermittently allow the microphone to pick up what the user says, but they do not allow the speakers to be loud enough for the user to hear what is being played. Unfortunately, such an approach is not usually effective, as these settings need to be continually readjusted. In many cases, the approach may be unsuccessful and a balance between having the microphone pick up what the user says and still having the speakers play may not be able to be reached. Yet another approach includes a system having an independent platform or circuitry for providing echo cancellation features. However, such a system introduces added expense and complexity, and requires communication between the platform or circuitry and the speakers and microphones.

### SUMMARY OF THE INVENTION

From the foregoing, it may be appreciated that a need has arisen for providing a method for clients to conduct telephony events. In accordance with the present invention, a telephony system and method are provided that substantially eliminate or reduce disadvantages and problems of conventional systems.

A telephony data switching method is disclosed. The method includes receiving data from first party and determining whether the data from the first party is substantially all speech data. In response to the data from the first party being substantially all speech data, the method also includes sending the data from the first party to the speaker and deactivating a data transfer state by preventing a transfer of data captured by a microphone operable to receive data from second party and to receive data output by a speaker. In response to the data from the first party not being substantially all speech data, then the method includes determining whether a silent data threshold has been reached. In response to the silent data threshold being reached, then the method also includes activating the data transfer state and recording data from the second party. If the data transfer state has been activated, then the method includes sending the data from the second party to the first party.

The present invention also comprises a telephony system. The system includes a speaker operable to output data received from a first party and a microphone operable to receive data from a second party and to receive data input from the speaker. The system also includes a logic module coupled to the microphone and to the speaker. The logic module is operable to receive the data from the first party and to determine whether the data from the first party is substantially all speech data. In response to the data from the first party being substantially all speech data, then the logic module is further operable to send the audio data from the first party to the speaker and deactivate a data transfer state by preventing transfer of data captured by the microphone. In response to the data from the first party not being substantially all speech data, then the logic module is further operable to determine whether a silent data threshold has been reached. In response to the silent data threshold being reached, then the logic module is further operable to activate the data transfer state and record data from the second party. If the data transfer state has been activated, then the logic module is further operable to send the audio data from the second party to the first party.

A telephony data switching application is also disclosed. The application includes a computer readable medium and application software residing on the computer readable medium. The application software is operable to receive data from a first party and to determine whether the data from the first party is substantially all speech data. If the data from the first party is substantially all speech data, then the application software is further operable to send the audio data from the first party to the speaker and deactivate a data transfer state by preventing transfer of data captured by a microphone operable to receive data from a second party and to receive data output by a speaker. If the data from the first party is not substantially all speech data, then the application software is further operable to determine whether a silent data threshold has been reached. If the silent data threshold has been reached, then the application software is further operable to activate the data transfer state and record data from the second party. If the data transfer state has been activated, then the application software is further operable to send the audio data from the second party to the first party.

The invention provides several important advantages. Various embodiments of the invention may have none, some, or all of these advantages. For example, the invention may provide the technical advantage of removing any echoes that would otherwise result with the use of traditional systems, where an originator of speech data hears as his or her speech is output by a recipient's speakers, which is picked up and subsequently output by that recipient's microphone. Such an advantage may allow a user to use his or her computer or other device as a speakerphone, with both internal speaker and microphone capability. Such an advantage also may reduce or eliminate the need to implement echo cancellation algorithms that would otherwise be required with other traditional systems and methods. Such an advantage may also remove the workload on processor and memory devices, freeing those devices to perform other useful functions for the user. Furthermore, such an advantage removes the need for the user to purchase external microphone and/or speaker equipment for telephony applications.

### BRIEF DESCRIPTION OF THE DRAWINGS

FIG. 1 is a block diagram of an embodiment of a telephony system utilizing teachings of the present invention;

FIG. 2 is an example of a speech range that may be used according to teachings of the present invention; and

FIG. 3 illustrates an example of a method that may be used in a telephony system utilizing teachings of the present invention.

### DETAILED DESCRIPTION OF THE DRAWINGS

FIG. 1 is a block diagram of an embodiment of a telephony system utilizing teachings of the present invention. In the embodiment illustrated in FIG. 1, system 10 includes a computer 20 that may be used to execute one or more applications managed by one or more logic modules 26. The present invention may provide a system and method for automatically activating and deactivating a data transfer state. That is, the system and method automatically activate and deactivate transfer of data captured by a microphone during a telephony event between at least two parties, usually a phone call or conversation. More specifically, the method and system may provide for determining whether data received from a first party by a second party is audio data, determining whether the received data should be sent to a speaker so that a second party may listen to the data, and when to activate transfer of the data captured by the second party's microphone. When transfer of the data captured by the second party's microphone is activated, or the data transfer state is activated, the method then sends the captured second party data as desired back to the first party. Such a method may reduce or remove echoes that may be produced by the second party's microphone receiving the first party's audio data as output by the second party's speakers. For example, a telephony application may be used to prevent transfer to the first party of data captured by the second party's microphone as long as the second party is listening to the first party's speech using the second party's speaker. If the telephony application determines that audio data being output by the second party's speaker is no longer speech data, it then allows the second party's audio data to be recorded and sent; otherwise, audio data may be dropped, recorded or cached. System 10 may continue the cycle of activating and deactivating transfer of the data captured by the microphone throughout the duration of a telephony event. The present invention also contemplates the use of a variety of audio data other than speech or voice data including, but not limited to, a variety of types of audio data such as music. The present description utilizes audio data for illustrative, and not limiting, purposes.

System 10 may be coupled to one or more remote devices 40 that are telephony-enabled, such as computers, from which it receives audio data from a first party. Remote device 40 may be coupled to computer 20 by any type of communication link 11, network media, such as public switched telephone network (PSTN), Internet Protocol (IP), wireless or other communication links such as Ethernet, cable, phone line or modem connection. FIG. 1 illustrates wireless communication links 11.

Computer 20 includes logic module 26 coupled to speaker 22 and microphone 24. In a particular embodiment, decoder modules 25 may be coupled to logic module 26 to encode and decode audio data as it is received from and/or sent over communication links 11. In a particular embodiment, speaker 22 and/or microphone 24 are operatively associated with computer 20, and may in such an embodiment be built-in, such as a laptop configuration. Microphone 24 is operable to receive as input, or “pick up,” audio data, from a first party using remote device 40, that is output from speaker 22, as well as audio data spoken by a second party who is using computer 20. Speaker 22 and microphone 24 may be operatively associated with a sound card or other similar functionality in computer 20, such as a Sound Blaster card available from Creative Technology Ltd. that may be used with the WINDOWS operating system.

Computer 20 may be a general or a specific purpose computer, including a mobile computer such as a laptop device, and may be a portion of a computer adapted to execute any one of the well-known MS-DOS, PC DOS, OS2, UNIX, MAC-OS and WINDOWS operating systems, or other operating systems including unconventional operating systems. Computer 20 may be a wireless device, such as a phone, personal digital assistant, or Internet appliance. Computer 20 includes a cache 21 accessible by logic module 26, which may include a random access memory (RAM) and read-only memory (ROM). Computer 20 may, in some embodiments include one or more audio data coder decoders (CODECs). Applications within logic module 26 may reside in cache 21 and/or an input/output (I/O) device 28, also accessible by logic module 26, which may be any suitable storage media. For example, in the embodiment shown in FIG. 1, computer 20 may access and/or include applications or software routines within logic module 26, depending on a particular application. Many methods for implementing a software architecture may be used and include, but are not limited to, object-oriented designs. Cache 21 and I/O device 28 may be suitable for storing all or a portion of these programs or routines and/or temporarily storing data during various processes performed by computer 20. Memory may be used, among other things, to support real-time analysis and/or for storing and/or processing of data.

Remote device 40 may also be one of many devices operable to couple with, or host, microphone 42 and speaker 44, including a personal digital assistant, phone, or wireless phone. Remote device 40 may also be a general or a specific purpose computer, and may be a portion of a computer adapted to execute any one of the well-known MS-DOS, PC DOS, OS2, UNIX, MAC-OS and WINDOWS operating systems, or other operating systems including unconventional operating systems. Remote device 40 also includes a microphone 42 to capture audio data spoken by a first party using remote device 40, and a speaker 44 to hear audio data spoken by a second party using computer 20, with whom the first party is conducting a telephony event.

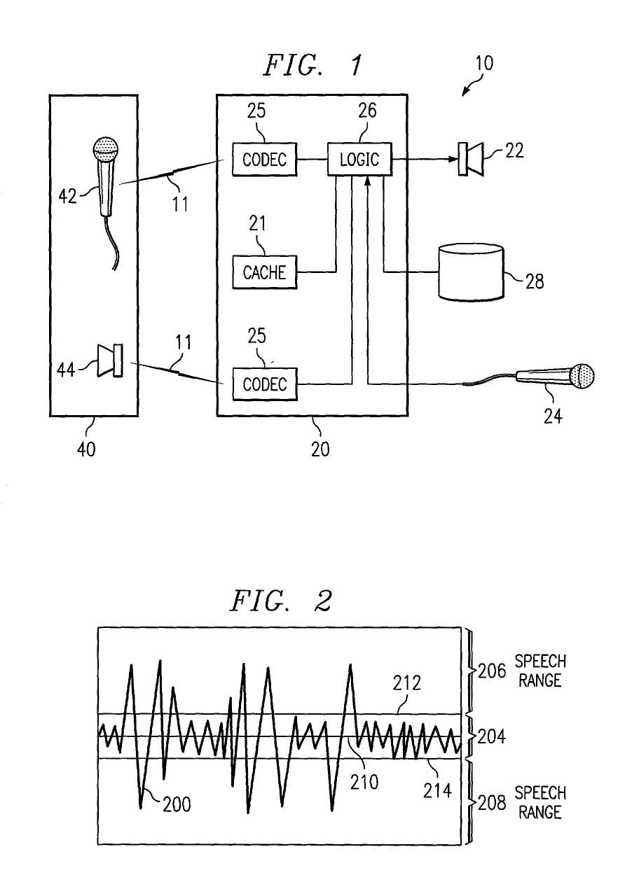

In general, audio data spoken by the first party using microphone 42 on remote device 40 is received over communication link 11 from remote device 40. The audio data may be received in blocks or data packets in a variety of formats, depending on the application. Optionally, and in the embodiment illustrated in FIG. 1, audio data is first received by CODECs 25, where it is decoded by the method used in that particular CODEC. Logic module 26 then analyzes some or all of the audio data received from the first party. In a particular embodiment, logic module 26 may analyze random samples of the audio data. If the audio data is in a “speech range”, system 10 performs a series of actions to reduce echoing of the first party's audio data through speaker 22 to microphone 24. One example for a speech range is discussed in further detail in conjunction with FIG. 2. The second party may listen to the audio data from the first party as it is projected through speaker 22 after being processed through logic module 26. Microphone 24 picks up, or captures, the audio data spoken by the second party, depending on whether or not ‘speech data’ from the first party is being output by the second party's speakers. Computer 20 may or may not stream out audio data from the second party that has been processed by logic module 26 to remote device 40. The first party using remote device 40 may then listen as that audio data is projected through speaker 44. Audio data from the second party is streamed over communication link 11 to remote device 40 in accordance with the methods of the present invention.

Although FIG. 1 illustrates a single computer 20 and remote device 40, the present invention contemplates the use of multiple computers 20 and 40, so that telephony events may be performed any number of parties. Alternatively or in addition, remote device 40 may also be similarly or identically structured to include the elements of computer 20. That is, the method contemplates telephony events between two computers that include logic module 26 and methods that may be performed in accordance with the present invention, that reduce or remove the effects of echoing from both first and second parties.

A variety of Internet telephony standards may be used including, but not limited to, H.323 for multimedia, Media Gateway Control Protocol (MGCP), which may facilitate voice over IP-to-PSTN intercom activity, Session Initiation Protocol (SIP), which may facilitate establishing, modifying, and terminating multimedia, single or multi-party calls, and others. For example, a call may originate from a user of an analog device over PSTN and be routed to a media gateway, which may convert a call to a format such as Realtime Transport Protocol (RTP) or RTP/IP for routing through an IP network. Depending on the telephony event, features such as bandwidth allocation (compression), security or others may be added to a telephony event by a number of methods, as known in the art.

The invention contemplates numerous methods for implementing a method such as the one discussed below in conjunction with FIG. 2. In a particular embodiment, logic module 26 may utilize a software architecture that includes one or more applications, and that may be logically composed of several classes and interfaces. These classes may operate in a distributed environment and communicate with each other using distributed communications methods, and may include a distributed component architecture such as Common Object Request Broker Architecture (CORBA), Java™ Remote Method Invocation (RMI), and Enterprise Java Beans.

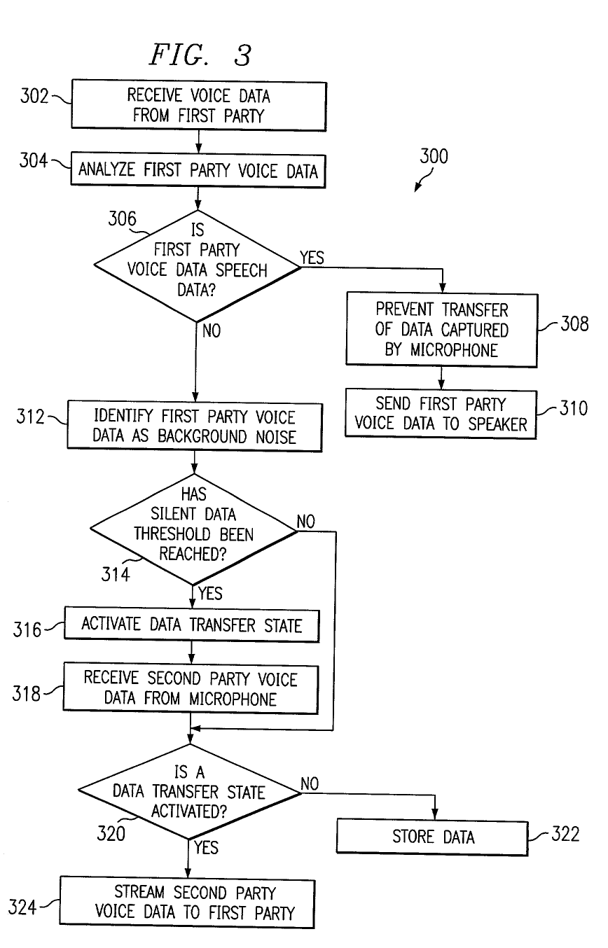

FIG. 2 is an example of a speech range that may be used according to teachings of the present invention. Because the invention contemplates the use of a variety of types of audio data in addition to speech data, and this description uses the phrases “speech data” and “speech range” for illustrative, and not limiting, purposes FIG. 2 illustrates an audio data signal 200 with an amplitude that varies over time. Audio data signal 200 represents, in a particular embodiment, audio data packets that may be formatted using a variety of methods. Audio data signal 200 is illustrated in FIG. 2 as modulated about a center level 210 that is within a non-talking or background noise range 204. As illustrated in FIG. 2, background noise range 204 is illustrated as defined between upper threshold 212 and lower threshold 214. These thresholds may be statically or dynamically determined, and may have values that depend on the application. For example, these thresholds may be adjusted to suit the voice volumes and/or frequencies of particular callers. Where audio data signal 200 is large enough, system 10 may determine that audio data signal 200 is ‘substantially all’ speech data. That is, system 10 may determine that the amplitude of audio data signal 200 exceeds either threshold 212 or 214. In a particular embodiment, the determination that audio data signal 200 is ‘substantially all’ speech data may include analysis of all or a portion of samples that represent audio data signal 200, including the use of various known statistical methods. As one example and not by limitation, audio data signal 200 may be considered speech data where a desired percentage, such as seventy percent, of a randomly selected portion of samples from audio data signal 200 exceed threshold 212 or 214. The term ‘substantially all’ is discussed in conjunction with FIG. 3.

FIG. 3 illustrates an example of a method that may be used in a telephony system utilizing teachings of the present invention. Method 300 generally includes the steps of receiving audio data from a first party at remote device 40, and analyzing this audio data in order to activate and deactivate a data transfer state; that is, the transfer of the data captured by microphone 24. This activation and deactivation allows the second party to hear audio data from the first party through speaker 22, speak into microphone 24 and send the second party's audio data to remote device 40. This process also reduces or removes any undesirable echoes of the first party's audio data that would otherwise be sent to remote device 40 along with the second party's audio data. Various embodiments may utilize fewer or more steps, and the method may be performed using a number of different implementations and different orders of workflow, depending on the application. Some of the steps may be performed in parallel. For example, audio data may be received and decoded in real-time, depending on the application.

The method begins in step 302, where audio data is received from a first party to be output by speaker 22. This audio data may also optionally be decoded in this step 302 by a number of known methods and/or CODECs. In step 304, logic module 26 analyzes the audio data to determine whether it is ‘substantially all’ speech data. The analysis may be performed as desired, based on the system implementation or application, to accommodate processing power, cache, memory and other requirements. In addition, such an analysis may be performed to achieve a desired amount of accuracy. For example, all or a portion of samples representing the audio data may be considered. In a particular embodiment, logic module 26 analyzes random samples of the audio data.

In step 306, the method queries whether the data is substantially all speech data. As discussed briefly in conjunction with FIG. 2, the invention contemplates the use of a variety of types of audio data in addition to speech data, and this description uses the phrase “speech data” for illustrative, and not limiting, purposes. Furthermore, a determination as to whether the audio data is substantially all speech data may be made using a variety of methods. In a particular embodiment, a pre-desired threshold, such as seventy percent of the analyzed samples, may be selected. If this pre-desired threshold is met or exceeded, the method may consider the audio data to be substantially all speech data. “Substantially” all may be a default value, and in some applications, may be dynamically adjusted. For example, a user may adjust a value for substantially all before, during, and/or after any given telephony event to his satisfaction, or to both parties' satisfaction, as desired. This adjustment may be performed using a number of methods, including the use of a graphical user interface (GUI) mechanism such as a slider bar. In a particular embodiment, a default value may be seventy. That is, where at least seventy percent of the analyzed samples are in the speech range, the method determines that the audio data is substantially all speech data. If the method determines that the audio data is substantially all speech data in step 306, the method deactivates a data transfer state; that is, it prevents transfer of the data captured by microphone 24 in step 308 to the other party. This deactivation prohibits any sending of data picked up by microphone 24 that would otherwise be projected through the output of speaker 22, while allowing the audio data received from the first party to be projected through speaker 22. In step 310, the method sends the audio data to speaker 22.

If, on the other hand, the method determines that the audio data is not substantially all speech data in step 306, the method proceeds to step 312, where it determines that the audio data is non-talking or background noise. The method then proceeds to step 314, where the method determines whether a silent data threshold has been reached. This determination may be made using a variety of methods. For example, a predetermined threshold, such as a sufficient number of consecutive blocks or samples of audio data that is within non-talking or background noise range 204 may be set. This threshold may be static or dynamic, and may depend on the application. As one example, and in a particular embodiment, a counter that monitors the number of consecutive blocks of audio data that is within non-talking or background noise range 204 may be incremented each time the method determines that the audio data is not speech data in step 306. For illustrative purposes, this counter may be delineated a ‘silent data counter’. After the determination as to whether or not the silent data threshold has been reached, the silent data counter may then be reset. Otherwise, the method in such an embodiment may continue to analyze samples of the audio data until sending of the data picked up by microphone 24 is activated. This process is advantageous because, for example, normal speech data includes periods of silence such as pauses between words, and the method determines when the silent data threshold has been met, the method assumes that the other party has stopped speaking.

If, in step 314, the silent data threshold has been reached, the data transfer state is activated in step 316. This activation permits audio data in step 318 to be received, or captured, from the second party through microphone 24, and subsequently transferred and/or recorded. In step 320, the method queries whether the data transfer state has been activated. If so, in step 324, the method streams out the audio data recorded from microphone 24. This data may be streamed in real-time, from a cache or other data storage area as desired and depending on the application, or a combination of both. This data may also be further encoded through CODEC 25 as desired. If, in step 320, the data transfer state has not been activated, the method elects in step 322 to not stream out the audio data picked up microphone 24. In a particular embodiment, the method may elect to store this data rather than streaming the data out, depending on the application.

A variety of methods may be used in step 306 to determine whether the audio data is substantially all speech data. As one example, and in a particular embodiment, a counter may be used to monitor the number of samples that had been determined to be in the speech range 206 or 208. For illustrative purposes, this counter may be delineated a ‘speech counter’. The speech counter may be reset after receipt of a decoded block of audio data received from the first party after step 302, and then the method may increment the speech counter after analyzing each sample within the received block. The speech counter may then be reset upon receipt of the next decoded block of audio data again in step 302. Similarly, the silent data counter may be reset after activation of the data transfer state by microphone 24 in step 316, and/or deactivation of the data captured by microphone 24 in step 308, as the method processes each decoded block of audio data.

While the invention has been particularly shown by the foregoing detailed description, various changes, substitutions and alterations may be readily ascertainable by those skilled in the art and may be made herein without departing from the spirit and scope of the present invention as defined by the following claims.

What is claimed is:

1. A telephony switching method, comprising:
receiving data from a first party;
determining whether the data from the first party is substantially all speech data;
in response to the data from the first party being substantially all speech data, then
sending the data from the first party to the speaker; and
deactivating a data transfer state by preventing a transfer of the data captured by a microphone operable to receive data from a second party and to receive data output by a speaker;
in response to the data from the first party not being substantially all speech data, then determining whether a silent data threshold has been reached;
if the silent data threshold has been reached, activating the data transfer state and recording data from the second party; and
if the data transfer state has been activated, sending the data from the second party to the first party.

2. The method of claim 1, further comprising decoding the data from the first party.

3. The method of claim 1, wherein substantially all speech data comprises a dynamically-adjustable amount of the data from the first party that is in a speech range.

4. The method of claim 3, wherein the speech range is adjustable.

5. The method of claim 1, wherein the data comprises audio data.

6. The method of claim 1, further comprising performing the steps of determining whether the data from the first party is substantially all speech data and determining whether the silent data threshold has been reached by employing object-oriented software instructions.

7. The method of claim 1, further comprising:
determining whether the data from the first party is substantially all speech data using logic residing on a computer;
determining whether the silent data threshold has been reached using the logic; and
wherein the microphone and the speaker are operatively associated with the computer.

8. A telephony switching system comprising
a speaker operable to output data received from a first party;
a microphone operable to receive data from a second party and to receive data input from the speaker;
a logic module coupled to the microphone and to the speaker and operable to receive the data from the first party;
determine whether the data from the first party is substantially all speech data;
in response to the data from the first party being substantially all speech data, then
send the audio data from the first party to the speaker; and
deactivate a data transfer state by preventing transfer of the data captured by the microphone;
in response to the data from the first party not being substantially all speech data, then determine whether a silent data threshold has been reached;
if the silent data threshold has been reached, activate the data transfer state and record data from the second party; and
if the data transfer state has been activated, send the audio data from the second party to the first party.

9. The system of claim 8, further comprising a decoder coupled to the logic module operable to receive and to decode the data.

10. The system of claim 8, wherein substantially all speech data comprises a dynamically-adjustable amount of the audio data from the first party that is in a speech range.

11. The system of claim 10, wherein the speech range is adjustable.

12. The system of claim 8, wherein the data comprises audio data.

13. The system of claim 8, wherein the microphone resides on a wireless device.

14. A telephony switching application, comprising
a computer readable medium; and
application software residing on the computer readable medium and operable to
receive data from a first party;
determine whether the data from the first party is substantially all speech data;
in response to the data from the first party being substantially all speech data, then
send the audio data from the first party to the speaker; and
deactivate a data transfer state by preventing transfer of the data captured by the microphone operable to receive data from a second party and to receive data output by a speaker;
if the data from the first party is not substantially all speech data, then determine whether a silent data threshold has been reached;
if the silent data threshold has been reached, activate the data transfer state and record data from the second party; and
if the data transfer state has been activated, send the audio data from the second party to the first party.

15. The application of claim 14, wherein the application software is further operable to decode the data from the first party.

16. The application of claim 14, wherein substantially all speech data comprises dynamically-adjustable amount of the data from the first party that is in a speech range.

17. The application of claim 16, wherein the speech range is adjustable.

18. The application of claim 14, wherein the data comprises audio data.

19. The application of claim 14, wherein the application software is operable to perform the steps of determining whether the data from the first party is substantially all speech data and determining whether the silent data threshold has been reached by employing object-oriented software instructions.

20. The application of claim 14, wherein the computer-readable medium is operatively associated with a computer, and the microphone and the speaker are operatively associated with the computer.

21. A telephony switching application, comprising:
a speaker operatively associated with a computer and operable to output data received from a first party;
a microphone operatively associated with the computer and operable to receive data from a second party and to receive data input from the speaker;
a logic module residing on the computer and coupled to the microphone and to the speaker and operable to
receive the data from the first party;
determine whether the data from the first party is substantially all speech data;
in response to the data from the first party being substantially all speech data, then
send the audio data from the first party to the speaker; and
deactivate a data transfer state by preventing transfer of the data captured by the microphone;
if the data from the first party is not substantially all speech data, then determine whether a silent data threshold has been reached;
if the silent data threshold has been reached, activate the data transfer state and record data from the second party; and
if the data transfer state has been activated, send the audio data from the second party to the first party.
